(19) United States
(12) Patent Application Publication
(10) Pub. No.: US 2019/0318353 A1
(43) Pub. Date: Oct. 17, 2019

(54) REAL TIME DATA PROCESSING PLATFORM FOR RESOURCES ON DELIVERY INTERACTIONS

(71) Applicant: BANK OF AMERICA CORPORATION, Charlotte, NC (US)

(72) Inventors: Joseph Benjamin Castinado, North Glenn, CO (US); Charles Russell Kendall, Snoqualmie, WA (US)

(21) Appl. No.: 15/952,059

(22) Filed: Apr. 12, 2018

(51) Int. Cl. G06Q 20/40; G06Q 20/36; G06Q 20/38; G06Q 20/02; G06Q 20/22; G06Q 20/08; H04L 9/06

(52) U.S. Cl. CPC G06Q 20/40; G06Q 20/367; G06Q 20/3825; H04L 67/104; G06Q 20/223; G06Q 20/0855; H04L 9/0637; G06Q 20/023

(57) ABSTRACT

Embodiments of the present invention provide a system operatively connected with a block chain distributed network and for using the block chain distributed network for processing resources-on-delivery interactions in real-time. Embodiments receive, at a node of a block chain distributed network, a smart contract associated with a resources-on-delivery interaction between a first entity and a second entity, access a distributed ledger, wherein the distributed ledger is updated based on communications from the block chain distributed network, receive an interaction request associated with the smart contract from a user device of at least one of a first user associated with the first entity or a second user associated with the second entity, determine, from the distributed ledger, that the interaction request meets one or more conditions of the smart contract, process the interaction request by executing the smart contract, and complete an interaction associated with the interaction request.

### FIELD

The present invention relates to improving processing of resources-on-delivery interactions in real time.

### BACKGROUND

Present systems cannot process interactions in real-time and also cannot effectively track processing of resources-on-delivery interactions. Therefore, there exists a need for a system to process all types of interactions in real-time and particularly to process resources-on-delivery interactions effectively.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the present invention address the above needs and/or achieve other advantages by providing apparatuses (e.g., a system, computer program product and/or other devices) and methods for processing resources-on-delivery interactions in real-time by operatively connecting with a block chain distributed network, receiving, at a node of a block chain distributed network, a smart contract associated with a resources-on-delivery interaction, wherein the smart contract is associated with a first entity and a second entity, accessing a distributed ledger, wherein the distributed ledger is updated based on communications from the block chain distributed network, receiving an interaction request associated with the smart contract from a user device of at least one of a first user associated with the first entity or a second user associated with the second entity, determining, from the distributed ledger, that the interaction request meets one or more conditions of the smart contract, processing the interaction request by executing the smart contract based on determining that the interaction request meets the one or more conditions of the smart contract, and in response to executing the smart contract, completing an interaction associated with the interaction request in real-time.

In some embodiments, the smart contract further comprises receiving at least a checklist associated with the smart contract.

In some embodiments, the present invention in response to receiving the interaction request, presents the checklist associated with the smart contract on the user device linked with initiation of the interaction request and receives one or more inputs associated with the checklist from the user device.

In some embodiments, receiving the smart contract further comprises receiving, at a node of the block chain distributed network, a first token associated with authorization of the interaction.

In some embodiments, completing the interaction comprises transmitting a request to the first user for a token associated with the authorization of the interaction, wherein the first user is a payor, in response to transmitting the request, receiving a second token from the first user, determine, from the distribution ledger, that the second token received from the first user matches the first token, and authorizing the interaction based on determining that the second token received from the first user matches the first token.

In some embodiments, completing the interaction comprises transferring resources associated with the interaction and the smart contract from a first account of a first resource entity associated with the first entity to a second account of a second resource entity associated with the second entity.

In some embodiments, the first resource entity and the second resource entity are financial institutions.

In some embodiments, the present invention executes the smart contract based on receiving a first signature from the first user and a second signature from the second user.

In some embodiments, the second user is a payee.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 presents a block diagram of a high-level real-time interaction flow environment, in accordance with embodiments of the present invention.

FIG. 2 presents a block diagram illustrating communication between one or more systems of a network for processing real-time interactions, in accordance with embodiments of the present invention.

FIG. 3A presents a traditional centralized ledger system.

FIG. 3B is a diagram illustrating a distributed ledger system used in embodiments of the invention.

FIG. 4 is a diagram illustrating a block chain distributed ledger system according to embodiments of the invention.

FIG. 5 is a flowchart illustrating a method for network authentication for real-time interaction using pre-authorized data record according to embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Systems, methods, and computer program products are herein disclosed that provide for processing resources-on-demand interactions in real-time. Typically, in cash-on-delivery transactions, a buyer pays cash to the seller upon delivery of goods or products. However, such a process will involve employees from both the entities carrying cash and will have no paper trail, thereby causing inconvenience to both seller entity and buyer entity. Moreover, the seller entity cannot use the cash instantly after receiving it from the buyer entity and has to wait until an employee of the seller entity deposits the cash received from an employee of the buyer entity into the seller entity account. Present invention provides a unique way to perform transactions, which will result in instant delivery of resources from a financial institution of the buyer to a financial institution of the seller. The real-time processing platform provided by the system is used to perform cash-on-delivery transactions by eliminating the need to exchange cash.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

In accordance with embodiments of the invention, the term “resource entity” may include any financial institution and the term “entity system” may include any organization that buys or sells products. In accordance with embodiments of the invention, an “interaction” may be a transaction, transfer of funds, transfer of resources, and may refer to any activities or communication between a user and an entity, between a user and resource entity, between a resource entity and an entity, activities or communication between multiple entities, communication between technology application and the like. In accordance with embodiments of the invention, a “resources-on-demand” interaction is a cash-on-demand or cash-on-delivery transactions. Typically a cash-on-demand transaction will include exchange of cash after delivery of products, goods, or the like.

In accordance with embodiments of the invention, an “account” or “resource credential” or “resource pool” is the relationship that a customer has with a resource entity such as a financial institution or the like. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the resource entity.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, the term “smart contract” refers to an agreement between one or more entities or one or more users participating in selling or purchase of goods, products, service, or the like. The smart contract may comprise one or more terms and conditions associated with the agreement.

As used herein, a “real-time interaction” refers to a resource transfer between users and/or entities participating in and leveraging a settlement network operating in real or near real-time (e.g., twenty-four hours a day, seven days a week), wherein settlement of the interaction occurs at or very close in time to the time of the interaction. A real-time interaction may include a payment, wherein a real-time interaction system enables participants to initiate credit transfers, receive settlement for credit transfers, and make available to a receiving participant funds associated with the credit transfers in real-time, wherein the credit transfer may be final and irrevocable. Real-time interactions or payments provide marked improvements over conventional interaction clearing and payment settlement methods (e.g., automated clearing house (ACH), wire, or the like) which can require several hours, days, or longer to receive, process, authenticate a payment, and make funds available to the receiving participant which may, in total, require several back-and-forth communications between involved financial institutions. In some cases, conventional settlement methods may not be executed until the end of the business day (EOB), wherein payments are settled in batches between financial institutions.

Real-time interactions reduce settlement time by providing pre-authentication or authentication at the time of a requested interaction in order to enable instantaneous or near-instantaneous settlement between financial institutions at the time of the interaction, wherein resources or funds may be made immediately available to a receiving participant (i.e., payee) following completion of the interaction. Examples of real-time interactions include business to business interactions (e.g., supplier payments), business to consumer interactions (e.g., legal settlements, insurance claims, employee wages), consumer to business interactions (e.g., bill pay, hospital co-pay, payment at point-of-sale), and peer to peer (P2P) interactions (e.g., repayment or remittance between friends and family). In a specific example, a real-time interaction may be used for payment of a utility bill on the due date of the bill to ensure payment is received on-time and accruement of additional fees due to late payment is avoided. In another example, real-time interactions may be especially beneficial for small entities and users (e.g., small merchants/businesses) that may have a heavier reliance on short-term funds and may not prefer to wait days for transaction settlements.

Real-time interactions not only provide settlement immediacy, but also provide assurance, fraud reduction, and bank-grade security to payments due to the inherent nature of the payment and user authentication infrastructure. Further, real-time interactions may reduce payment processing costs due to the simplified nature of required communication when compared to conventional settlement methods. In some embodiments, real-time interaction systems further include information and conversation tools that financial institutions may utilize to enhance a settlement experience for participants.

A system leveraging a real-time interaction settlement network allows for an interaction, transaction, payment, or the like to be completed between participating parties (e.g., financial institutions and/or their customers) via an intermediary clearing house acting in the role of a neutral party. Participant accounts are held at the clearing house and administered by both the participant and the clearing house. In this way, the clearing house is able to transfer resources or funds between the participant accounts on behalf of the participants in order to settle interactions.

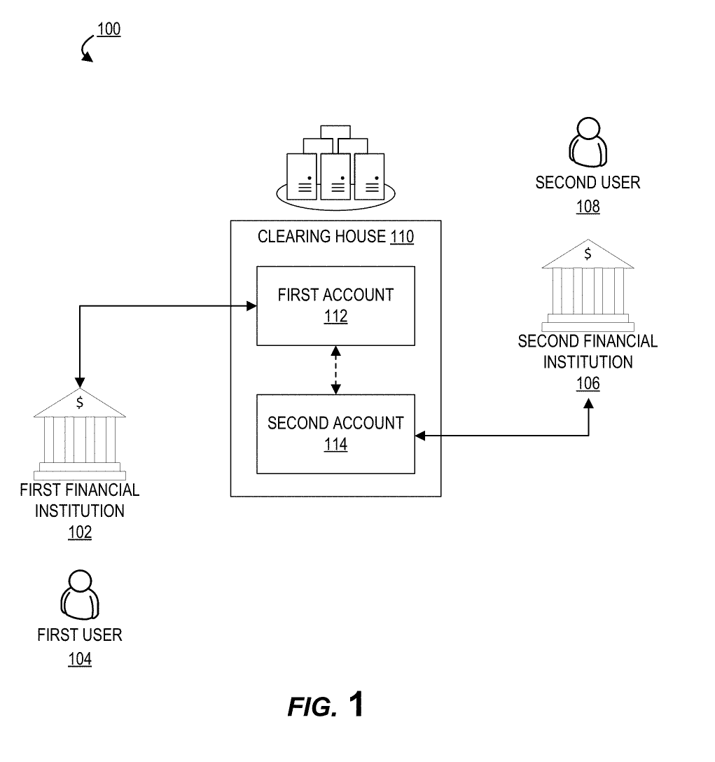

FIG. 1 illustrates a block diagram of a high-level real-time interaction flow environment 100, in accordance with one embodiment of the invention. In the illustrated environment, a first user 104 is associated with (i.e., a customer of) a first financial institution 102 and a second user 108 is associated with a second financial institution 106. The customers of the first financial institution 102 and second financial institution 106 may be individual users or large business entities. A clearing house 110 comprises a first account 112 associated with the first financial institution 102 and a second account 114 associated with the second financial institution 106. The first account 112 and the second account 114 are accessible by each associated financial institution and the clearing house 110 which acts as a trusted intermediary during settlement between the financial institutions. Resources or funds may be transferred by each financial institution to and from their associated account. Transfers between the first account 112 and the second account 114 are administered by the clearing house 110 pending authentication and authorization by participating parties of each transfer.

In one embodiment, the first user 104 and the second user 108 are participants of a real-time interaction system, wherein the first user 104 (i.e., the payor) initiates a credit transfer to the second user 108 (i.e., the payee). In a specific example, the first user 104 is required to initiate the transfer from the first financial institution 102, wherein the first user 104 provides authentication information to authenticate the identity of the first user 104 and to validate that an account of the first user 104 held at the first financial institution 102 contains at least a sufficient amount of available funds to fulfill the transfer. While in one embodiment, the first user 104 is required to initiate the transfer from a physical, brick-and-mortar location of the first financial institution 102, in alternative embodiments described herein, the transfer may be initiated from other locations wherein a user is not required to be at a brick-and-mortar location (e.g., via an electronic application, a website, or the like).

The first user 104, as the sending participant (i.e., payor), is required to authenticate his or her identity by providing information or credentials to the associated financial institution. For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

Upon initiating an interaction, the first user 104 becomes obligated to pay the amount of the interaction, wherein the interaction cannot be canceled by the first user 104 following initiation and transmission of communication to a receiving participant. The second user 108, as the receiving participant (i.e., the payee), receives communication to accept payment following similar user authentication requirements. Communication between participants for the interaction is transmitted between the financial institutions via the clearing house 110 which directs the payment to the appropriate financial institution associated with the receiving participant. The transfer of funds occurs between the financial institution accounts 112 and 114 associated with the financial institutions 102 and 106 on behalf of their associated users, wherein the interaction may be settled immediately, concurrent with the interaction. As settlement occurs between the representative financial institutions, debiting and crediting of individual user accounts may be managed at each financial institution with their associated customers. As the interaction is settled immediately, funds may be made available for use in real or near real-time.

It should be understood that while the illustrated embodiment of FIG. 1A depicts only first and second users, financial institutions, and accounts, other embodiments of a real-time interaction network may comprise a plurality of accounts associated with a plurality financial institutions. In some embodiments, the environment 1100 may further comprise more than one clearing house 110 (e.g., TCH, the Federal Reserve, and the like) that receive and process interaction requests as described herein. Financial institutions may include one or more community banks, regional banks, credit unions, corporate banks, direct connect financial institutions, and the like. In some embodiments, the interactions may be performed by using a block chain distributed interaction network.

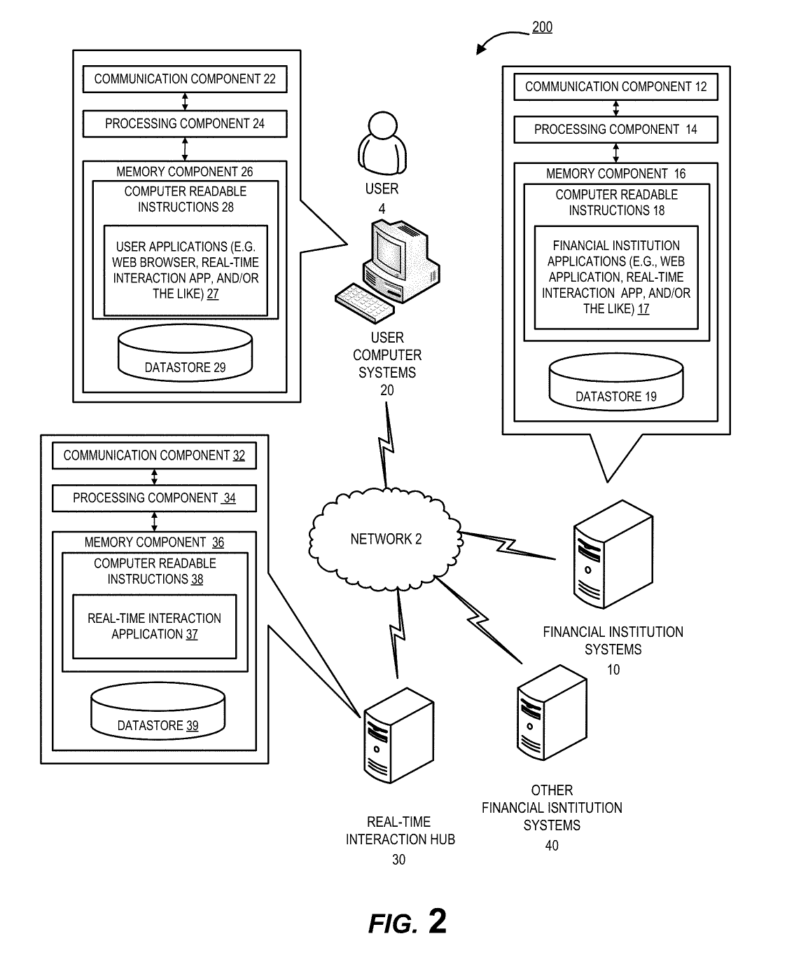

FIG. 2 presents a block diagram 200 illustrating communication between one or more systems of a network for processing real-time interactions, in accordance with embodiments of the invention. As illustrated in FIG. 2, one or more financial institution systems 10 are operatively coupled, via a network 2, to user computer systems 20, a plurality of user computer systems, and/or one or more other systems (not illustrated). The user computer systems 20 may be user devices of customers of the financial institution systems 10. In one embodiment, the user computer systems 20 may be computer systems of businesses or entities which purchase or sell products, goods, services, or the like. In one particular embodiment of the present invention, the user computer systems 20 may be user devices of employees of a buyer entity or a seller entity, wherein the buyer entity and seller entity are customers of the financial institution systems 10 and other financial institution systems 40. In this way, the user 4 (e.g., one or more associates, employees, agents, contractors, sub-contractors, third-party representatives, customers, or the like of the entities), through a user application 27 (e.g., web browser, real-time interaction application, or the like), may access financial institution applications 17 (e.g., website, real-time interaction application, or the like) of the financial institution systems 10 to perform real-time resources-on-demand interactions. In one embodiment, the user computer systems 20 may be associated with an independent user. In such an embodiment, the user 4 through a user application 27 (e.g., web browser, real-time interaction application, or the like), may access financial institution applications 17 (e.g., website, real-time interaction application, or the like) of the financial institution systems 10 to perform real-time resources-on-demand interactions. In some embodiments, the system of the present invention as shown may be part of the financial institution system 10. In alternate embodiments, the system of the present invention may be a separate independent system communicating with other systems shown in FIG. 2.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 2, the financial institution systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the components of the user computer systems 20, real-time interaction hub 30, or other financial institution systems 40. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like. In one embodiment of the present invention, the one or more processing components 14 automatically implement a distributed ledger used for processing transactions, tracking balances between multiple users of the financial institutions, and tracking balances between multiple financial institutions.

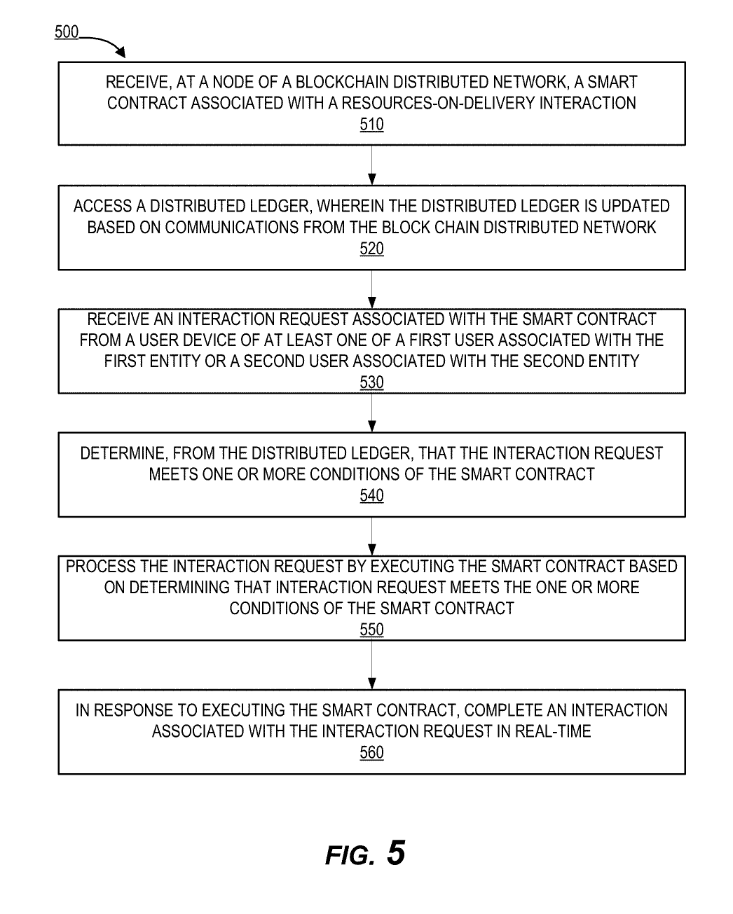

As further illustrated in FIG. 1, the financial institution systems 10 comprise computer-readable instructions 18 stored in the memory component 16, which in one embodiment includes the computer-readable instructions 18 of the financial institution applications 17 (e.g., website application, real-time interaction application, online banking application, and/or the like). In some embodiments, the features of the real-time interaction application may be embedded into the online banking application. In some embodiments, the one or more memory components 16 include one or more data stores 19 for storing data related to the financial institution systems 10, including, but not limited to, data created, accessed, and/or used by the financial institution application 17. The one or more data stores may store the copies of the distributed ledger, historical data, and/or other information. In one embodiment of the present invention, the real-time interaction application comprises a rules engine to perform one or more steps described in the process flows of FIG. 5.

As illustrated in FIG. 2, users 4 may access the financial institution application 17, or other applications, through a user computer system 20. The user computer system 20 may be a desktop, mobile device (e.g., laptop, smartphone device, PDA, tablet, or other mobile device), or any other type of computer that generally comprises one or more communication components 22, one or more processing components 24, and one or more memory components 26.

The one or more processing components 24 are operatively coupled to the one or more communication components 22 and the one or more memory components 26. The one or more processing components 24 use the one or more communication components 22 to communicate with the network 2 and other components on the network 2, such as, but not limited to, the user computer systems 20, other financial institution systems 40, and/or other systems. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with the users 4.

As illustrated in FIG. 2, the user computer systems 20 may have computer-readable instructions 28 stored in the one or more memory components 26, which in one embodiment includes the computer-readable instructions 28 for user applications 27, such as real-time interaction application (e.g., apps, applet, or the like), portions of real-time interaction application, a web browser, an online banking application, or other apps that allow the user 4 to take various actions, including allowing the user 4 to access applications located on other systems, or the like. In some embodiments, the user 4 utilizes the user applications 27, through the user computer systems 20, to access the financial institution applications 17 to perform interactions or analysis.

As further illustrated in FIG. 2, the real-time interaction hub 30 generally comprises a communication component 32, a processing component 34, and a memory component 36. As used herein, the term “processing component” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing component 34 is operatively coupled to the communication component 32 and the memory component 36. The processing component 248 uses the communication component 32 to communicate with the network 2 and other devices on the network 2, such as, but not limited to the financial institution system 10, other financial institution systems 40 and the user computer systems 20. As such, the communication component 32 generally comprises a modem, server, or other device for communicating with other devices on the network 2.

In one embodiment of the present invention, the real-time interaction application in the user computer systems 20, the other financial institution systems 40, and the financial institution systems 10 may comprise a special interaction interface to display information associated with the one or more distributed ledgers, the balances of accounts, the process steps discussed herein and the automatic actions that may be taken in response to the interaction processes discussed herein. Such information may be displayed to the user and the interface may receive information associated with the rules and/or the one or more distributed ledgers or otherwise from the user.

As further illustrated in FIG. 2, the real-time interaction hub 30 comprises computer-readable instructions 38 stored in the memory component 36, which in one embodiment includes the computer-readable instructions 38 of a real-time interaction application 37. In some embodiments, the memory component 36 includes data storage 39 for storing data related to the system environment, but not limited to data created and/or used by the real-time interaction application 37. The real-time interaction applications in the financial institution systems 10 and user computer systems 20 may be parts or replicas, or extensions of the real-time interaction application 37. The financial institution systems 10 and other financial institution systems 40 communicate with the real-time interaction hub 30, via the real-time interaction applications stored in the memory component 16 and memory component 26, to perform one or more interactions (e.g., resources-on-delivery interactions). The real-time interaction hub 30 acts as the clearing house 110 shown in FIG. 1. In some embodiments, the real-time interaction hub may be maintained by a third party institution. In some embodiments, the real-time interaction hub 30 may be maintained by the financial institution systems 10 or financial institution systems 40.

In the embodiment illustrated in FIG. 2 and described throughout much of this specification, the real-time interaction application 37 may determine resource balances, process in real-time or near real-time interactions, and settle interactions in real-time or near real-time.

The system of the present invention may be an overarching system which communicates with multiple systems shown in FIG. 2. In some embodiments, the system may be a part of the financial institution system 10. In some embodiments, the system may be a part of an independent system comprising a communication component, a processing component, a memory component comprising computer readable instructions to execute one or more process flows described herein. In some embodiments, the real-time interaction hub 30 may be maintained or owned by any of the financial institution system 10 and/or other financial institution systems 40.

It is understood that the servers, systems, and devices described herein illustrate one embodiment of the invention. It is further understood that one or more of the servers, systems, and devices can be combined in other embodiments and still function in the same or similar way as the embodiments described herein.

Some embodiments of this invention utilize a distributed ledger, such as a distributed ledger as used in a block chain infrastructure. Block chain may use a specialized distributed ledger system for storing each process point of the complete payment structure for each interaction together in a block chain style format. The blocks store data packets of information pertaining to the processing of that particular transaction within the process and are chained together to form a time stamped historic record of the transaction processed from the client origination to external clearing. Using metadata the system allows for searching and finding complex tracking and tracing across transactions or accounts.

“Block chain” as used herein refers to a decentralized electronic ledger of data records which are authenticated by a federated consensus protocol. Multiple computer systems within the block chain, referred to herein as “nodes” or “compute nodes,” each comprise a copy of the entire ledger of records. Nodes may write a data “block” to the block chain, the block comprising data regarding a transaction. In some embodiments, only miner nodes may write transactions to the block chain. In other embodiments, all nodes have the ability to write to the block chain. In some embodiments, the block may further comprise a time stamp and a pointer to the previous block in the chain. In some embodiments, the block may further comprise metadata indicating the node that was the originator of the transaction. In this way, the entire record of transactions is not dependent on a single database which may serve as a single point of failure; the block chain will persist so long as the nodes on the block chain persist. A “private block chain” is a block chain in which only authorized nodes may access the block chain. In some embodiments, nodes must be authorized to write to the block chain. In some embodiments, nodes must also be authorized to read from the block chain. Once a transactional record is written to the block chain, it will be considered pending and awaiting authentication by the miner nodes in the block chain.

“Miner node” as used herein refers to a networked computer system that authenticates and verifies the integrity of pending transactions on the block chain. The miner node ensures that the sum of the outputs of the transaction within the block matches the sum of the inputs. In some embodiments, a pending transaction may require validation by a threshold number of miner nodes. Once the threshold number of miners has validated the transaction, the block becomes an authenticated part of the block chain. By using this method of validating transactions via a federated consensus mechanism, duplicate or erroneous transactions are prevented from becoming part of the accepted block chain, thus reducing the risk of data record tampering and increasing the security of the transactions within the system.

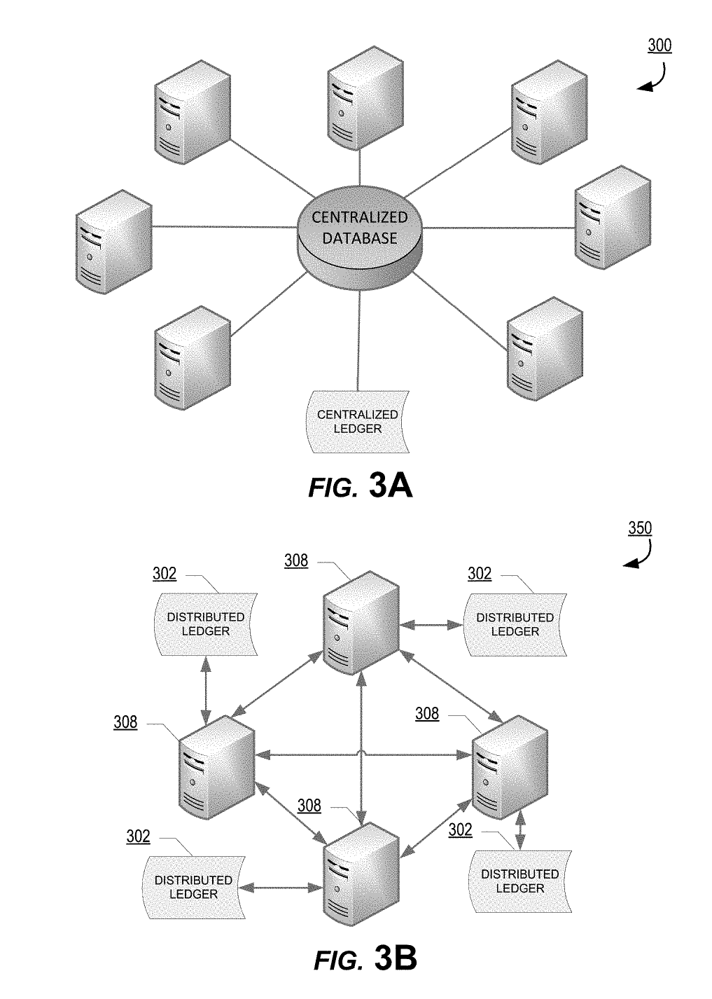

FIG. 3A illustrates a centralized database architecture environment 300, in accordance with one embodiment of the present invention. The centralized database architecture comprises multiple nodes from one or more sources and converge into a centralized database. The system, in this embodiment, may generate a single centralized ledger for data received from the various nodes. The single centralized ledger for data provides a difficult avenue for reviewing a record of a single transaction or payment process as it moves through the various applications for processing. There is no means to track the individual payment through the process at any point until it has been completely posted. Even at that point, with the amount of data a centralized database digests regularly in a complex payment structure, the ability to accurately track and trace a single transaction point or account through the process is not possible.

FIG. 3B provides a general block chain system environment architecture 350, in accordance with one embodiment of the present invention. Rather than utilizing a centralized database of data for instrument conversion, as discussed above in FIG. 3A, various embodiments of the invention may use a decentralized block chain configuration or architecture as shown in FIG. 3B in order to facilitate the converting of an instrument from a non-secured or secured format to a verified secured format. Such a decentralized block chain configuration ensures accurate mapping of resources available within an account associated with an instrument. Accordingly, a block chain configuration may be used to maintain an accurate ledger of transactions and the processing of each transaction through the processing applications by generation of a time stamped block and building of one or more blocks for each stage of the processing for the transaction. In this way, the system builds a traceable and trackable historic view of each transaction within each account, capable of being searched and identified.

A block chain is a distributed database that maintains a list of data records, such as real-time resource availability associated with one or more accounts or the like, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. As such, the status of the instrument and the resources associated therewith can be validated and cleared by one participant.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In some embodiments, the block chain system is closed, as such the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria.

As mentioned above and referring to FIG. 3B, a block chain system 350 is typically decentralized—meaning that a distributed ledger 302 (i.e., a decentralized ledger) is maintained on multiple nodes 308 of the block chain 350. One node in the block chain may have a complete or partial copy of the entire ledger or set of transactions or smart contracts and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains. Similarly, any of the nodes can validate smart contracts, add smart contracts to the block chain, broadcast the smart contract and its execution to other nodes. In some embodiments, the nodes 308 of the system might be financial institutions that function as gateways for other financial institutions. For example, a credit union might hold the account, but access the distributed system through a sponsor node.

Various other specific-purpose implementations of block chains have been developed. These include distributed domain name management, decentralized crowd-funding, synchronous/asynchronous communication, decentralized real-time ride sharing and even a general purpose deployment of decentralized applications.

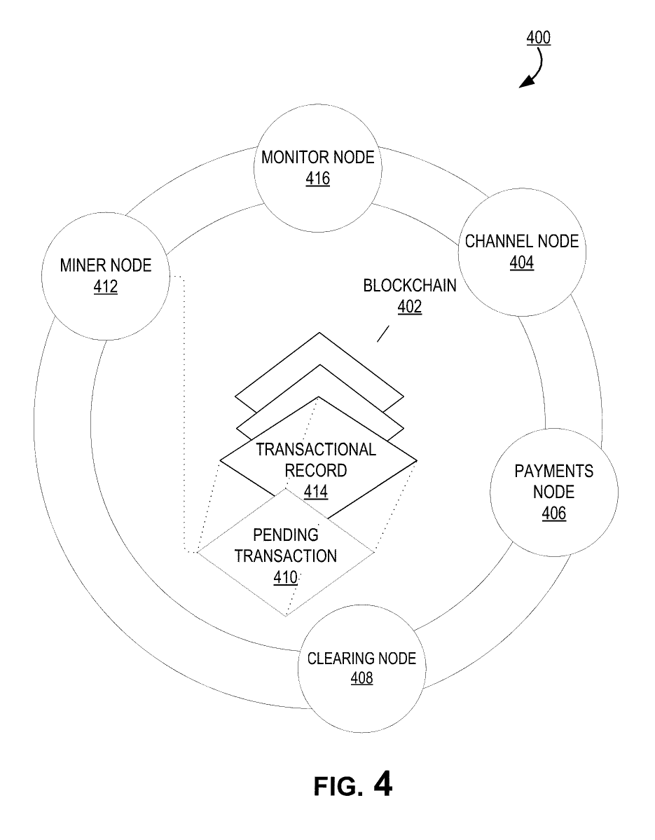

FIG. 4 provides a high level process flow illustrating node interaction within a block chain system environment architecture 400, in accordance with one embodiment of the present invention. As illustrated and discussed above, the block chain system may comprise at least one or more nodes used to generate blocks and process transactional records for generation of the life-cycle record recreation.

In some embodiments, the channel node 404, payments node 406, or the clearing node 408 may publish a pending transaction 410 to the block chain 402. At this stage, the transaction has not yet been validated by the miner node(s) 412, and the other nodes will delay executing their designated processes. The miner node 412 may be configured to detect a pending transaction 410 or steps in the processing of the payment transaction in the block chain and conduct its processes to evaluate the validity of the data therein. Upon verifying the integrity of the data in the pending transaction 410, the miner node 412 validates the transaction and adds the data as a transactional record 414, which is referred to as a block in some embodiments of the application, to the block chain 402. Once a transaction has been authenticated in this manner, the nodes will consider the transactional record 414 to be valid and thereafter execute their designated processes accordingly. The transactional record 414 will provide information about what process or application the payment transaction was just processed through and metadata coded therein for searchability of the transactional record 414 within a distributed ledger.

In some embodiments, the system may comprise at least one additional miner node 412. The system may require that pending transactions 410 be validated by a plurality of miner nodes 412 before becoming authenticated blocks on the block chain. In some embodiments, the systems may impose a minimum threshold number of miner nodes 412 needed to verify each pending transaction. The minimum threshold may be selected to strike a balance between the need for data integrity/accuracy versus expediency of processing. In this way, the efficiency of the computer system resources may be maximized.

Furthermore, in some embodiments, a plurality of computer systems are in operative networked communication with one another through a network. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

In some embodiments, the computer systems represent the nodes of the block chain, such as the miner node or the like. In such an embodiment, each of the computer systems comprise the block chain, providing for decentralized access to the block chain as well as the ability to use a consensus mechanism to verify the integrity of the data therein. The system may be operatively connected with a block chain distributed network and for using the block chain distributed network for facilitating network authentication for real-time interactions using pre-authorized data records.

Referring now to FIG. 5, a flowchart illustrates a method 500 for real-time processing of resources-on-demand transactions. As shown in block 510, the system receives, at a node of the blockchain distributed network, a smart contract associated with a resources-on-delivery interaction. The smart contract may be an agreement between a first entity and a second entity associated with purchase of good or products. For example, the first entity may be a restaurant and a second entity may be a product distributor. A user (employees, contractors, sub-contractors, or the like) associated with the first entity or the second entity may initiate a smart contract associated with sale/purchase of product. The smart contract may include at least a checklist, one or more conditions, interaction information, or the like. In an example, where the first entity (i.e., restaurant) is purchasing meat products from the second entity (i.e., meat distributor), the checklist may include options such as “product delivered on-time,” “matches the inventory,” “same payment amount” or the like. During delivery of products, this checklist may be filled by a first user from the first entity or a second user form the second entity. One or more conditions may include rules for execution of the smart contract. For example, the smart contract may be executed only when all check boxes of the checklist have been marked and/or when only when signatures can be validated. Interaction information may include payment credentials (financial institution information of both the first entity (payor) and the second entity (payee)), interaction amount (i.e., price of the total order associated with the purchase/sale), a first token associated with the authorization of the interaction (the first entity (payor) adds the first token to the smart contract for authorization of the interaction and transfer of resources associated with the interaction amount during the execution of the smart contract).

As shown in block 520, the system accesses a distributed ledger, wherein the distributed ledger is updated based on communications from the blockchain distributed network. For example, the system may access the distributed ledger to access the smart contract. In some embodiments, the system may have continuous real-time access to the distributed ledger, such that the system can access the interactions, smart contracts, or the like received by the block chain distributed network.

As shown in block 530, the system receives an interaction request associated with the smart contract from a user device of at least one of the first user associated with the first entity or the second user associated with the second entity. The interaction request is a request to execute the smart contract. In one embodiment, the first user initiates the interaction request on a first user computer system provided by the first entity. In another embodiment, the second user initiates the interaction request on a second user device provided by the second entity. The interaction request is initiated by the first user or the second user on the day of the delivery of products. In response to receiving the interaction request, the system presents the checklist from the smart contract presented in the distributed ledger on the user device linked with the initiation of the interaction request. For example, if the first user (owner or employee of the restaurant) initiates the interaction request on a first user device, the system displays the checklist on the first user device via a system user interface. Upon inspecting the products delivered by the second user, the first user checks one or more options on the checklist and submits it to the system. The system may then present a signature page and prompt the first user to provide a signature to execute the smart contract, at which point the first user provides a signature on the signature page. In some embodiments, the system may then present a second signature page on the first user device and may prompt for a signature of the second user, at which point the first user may pass the first user device to the second user for the signature. In alternate embodiments, the system may present the second signature page on the second user device of the user before, after, or at the same time the system presents the signature page on the first user device.

In some embodiments, there may be two check-lists, a first checklist for the first entity and a second checklist for the second entity, wherein the first checklist may be associated with the inspection of the products delivered by the second entity and the second check-list may be associated with regulations (e.g., permits or licenses of the first entity) to purchase the products. In some cases, the second checklist may be associated with any other rules. Upon seeing the first checklist, the first user may inspect the delivered products and provide a signature (or an execution code) for executing the contract. In some cases, where purchase of certain type of goods and products may require permits or licenses, the system presents the second checklist comprising options related to permits and licenses. The second user may verify that the first entity has license or permit to buy the products and provide a signature (or an execution code) for executing the contract.

As shown in block 540, the system determines, from the distributed ledger, that the interaction request meets one or more conditions of the smart contract. As discussed above, the one or more conditions may be rules executing the smart contract. In an example, where the one or more conditions include executing the smart contract only when all options in the checklists are marked, the system may identify whether all options in the checklists are filled or marked by the first user and the second user during the delivery of products. In some cases, wherein all the options in the checklists are not marked, the system delivers notifications to the first entity, second entity, first user, second user, or the like. The notifications may include failure to execute the smart contract and the reasons associated with it.

As shown in block 550, the processes the interaction request by executing the smart contract based on determining that interaction request meets the one or more conditions of the smart contract. Executing the smart contract comprises initiating an interaction (transaction) based on the interaction information present in the smart contract. The system may prompt the first user on the first user device to provide a token for authorization of the interaction. In response to prompting the first user, the system may receive a second token from the first user, wherein the second token may or may not match the first token present in the smart contract. The system determines whether the second token received from the user matches the first token. If the second token matches the first token, the system authorizes the interaction. In the case, where the second token does not match the first token, the system re-prompts the first user to provide a token for authorization of the interaction.

As shown in block 560, the system, in response to executing the smart contract, completes an interaction associated with the interaction request in real-time. The system completes the interaction by transferring, in real-time, resources from a first account of a first financial institution associated with the first entity to a second account of a second financial institution associated with the second entity via the real-time interaction hub 30. Processing and completing the transaction may be implemented as discussed in FIG. 1 through FIG. 4. The system may process multiple resources-on-delivery interactions associated with multiple deliveries of products between multiple entities at the same time. Multiple users of entities may access the system at the same time to execute one or more smart contracts. A similar process flow may be implemented for cash transactions or cash on delivery transactions between independent users. In some embodiments, one or more steps of the process flow 500 illustrated in FIG. 5, may be performed without using the blockchain distributed network.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 8333US1.014033.3188 | To be assigned | NETWORK | Concurrently |
| | | AUTHENTICATION FOR | herewith |
| | | REAL-TIME INTERACTION | |
| | | USING PRE-AUTHORIZATED | |
| | | DATA RECORD | |
| 8334US1.014033.3189 | To be assigned | REAL-TIME NETWORK | Concurrently |
| | | PROCESSING NUCLEUS | herewith |
| 8335US1.014033.3190 | To be assigned | REAL-TIME DATA | Concurrently |
| | | PROCESSING PLATFORM | herewith |
| | | WITH INTEGRATED | |
| | | COMMUNICATION | |
| | | LINKAGE | |
| 8337US1.014033.3192 | To be assigned | INTERNET-OF-THINGS | Concurrently |
| | | ENABLED REAL-TIME | herewith |
| | | EVENT PROCESSING | |

What is claimed is:

1. A system operatively connected with a block chain distributed network and for using the block chain distributed network for processing resources-on-delivery interactions in real-time, the system comprising:
a memory device; and
a processing device operatively coupled to the memory device, wherein the processing device is configured to execute computer readable program code to:
receive, at a node of a block chain distributed network, a smart contract associated with a resources-on-delivery interaction, wherein the smart contract is associated with a first entity and a second entity;
access a distributed ledger, wherein the distributed ledger is updated based on communications from the block chain distributed network;
receive an interaction request associated with the smart contract from a user device of at least one of a first user associated with the first entity or a second user associated with the second entity;
determine, from the distributed ledger, that the interaction request meets one or more conditions of the smart contract;
process the interaction request by executing the smart contract based on determining that the interaction request meets the one or more conditions of the smart contract; and
in response to executing the smart contract, complete an interaction associated with the interaction request in real-time.

2. The system of claim 1, wherein the smart contract further comprises receiving at least a checklist associated with the smart contract.

3. The system of claim 2, wherein the processing device is configured to:
in response to receiving the interaction request, presenting the checklist associated with the smart contract on the user device linked with initiation of the interaction request; and
receiving one or more inputs associated with the checklist from the user device.

4. The system of claim 1, wherein receiving the smart contract further comprises receiving, at a node of the block chain distributed network, a first token associated with authorization of the interaction.

5. The system of claim 4, wherein completing the interaction comprises:
transmitting a request to the first user for a token associated with the authorization of the interaction, wherein the first user is a payor;
in response to transmitting the request, receiving a second token from the first user;
determining, from the distribution ledger, that the second token received from the first user matches the first token; and
authorizing the interaction based on determining that the second token received from the first user matches the first token.

6. The system of claim 1, wherein completing the interaction comprises:
transferring resources associated with the interaction and the smart contract from a first account of a first resource entity associated with the first entity to a second account of a second resource entity associated with the second entity.

7. The system of claim 6, wherein the first resource entity and the second resource entity are financial institutions.

8. The system of claim 1, wherein the processing device is configured to execute the smart contract based on receiving a first signature from the first user and a second signature from the second user.

9. The system of claim 1, wherein the second user is a payee.

10. A computer program product for using a block chain distributed network for processing resources-on-delivery interactions, wherein the computer program product comprises at least one non-transitory computer readable medium comprising computer readable instructions, the instructions, when executed by a computer processor, cause the computer processor to:
receive, at a node of a block chain distributed network, a smart contract associated with a resources-on-delivery interaction, wherein the smart contract is associated with a first entity and a second entity;
access a distributed ledger, wherein the distributed ledger is updated based on communications from the block chain distributed network;
receive an interaction request associated with the smart contract from a user device of at least one of a first user associated with the first entity or a second user associated with the second entity;
determine, from the distributed ledger, that the interaction request meets one or more conditions of the smart contract;
process the interaction request by executing the smart contract based on determining that the interaction request meets the one or more conditions of the smart contract; and
in response to executing the smart contract, complete an interaction associated with the interaction request in real-time.

11. The computer program product of claim 10, wherein the smart contract further comprises receiving at least a checklist associated with the smart contract.

12. The computer program product of claim 11, wherein the computer readable instructions further cause the computer processor to:
in response to receiving the interaction request, presenting the checklist associated with the smart contract on the user device linked with initiation of the interaction request; and
receiving one or more inputs associated with the checklist from the user device.

13. The computer program product of claim 10, wherein receiving the smart contract further comprises receiving, at a node of the block chain distributed network, a first token associated with authorization of the interaction.

14. The computer program product of claim 13, wherein completing the interaction comprises:
transmitting a request to the first user for a token associated with the authorization of the interaction, wherein the first user is a payor;
in response to transmitting the request, receiving a second token from the first user;
determining, from the distribution ledger, that the second token received from the first user matches the first token; and
authorizing the interaction based on determining that the second token received from the first user matches the first token.

15. The computer program product of claim 10, wherein completing the interaction comprises:
transferring resources associated with the interaction and the smart contract from a first account of a first resource entity associated with the first entity to a second account of a second resource entity associated with the second entity.

16. A computer implemented method for using the block chain distributed network for processing resources-on-delivery interactions, the computer implemented method comprising:
receiving, at a node of a block chain distributed network, a smart contract associated with a resources-on-delivery interaction, wherein the smart contract is associated with a first entity and a second entity;
accessing a distributed ledger, wherein the distributed ledger is updated based on communications from the block chain distributed network;
receiving an interaction request associated with the smart contract from a user device of at least one of a first user associated with the first entity or a second user associated with the second entity;
determining, from the distributed ledger, that the interaction request meets one or more conditions of the smart contract;
processing the interaction request by executing the smart contract based on determining that the interaction request meets the one or more conditions of the smart contract; and
in response to executing the smart contract, completing an interaction associated with the interaction request in real-time.

17. The computer implemented method of claim 16, wherein the smart contract further comprises receiving at least a checklist associated with the smart contract.

18. The computer implemented method of claim 17, further comprising:
in response to receiving the interaction request, presenting the checklist associated with the smart contract on the user device linked with initiation of the interaction request; and
receiving one or more inputs associated with the checklist from the user device.

19. The computer implemented method of claim 16, wherein completing the interaction comprises:
transferring resources associated with the interaction and the smart contract from a first account of a first resource entity associated with the first entity to a second account of a second resource entity associated with the second entity.

20. The computer implemented method of claim 16, wherein the method further comprises executing the smart contract based on receiving a first signature from the first user and a second signature from the second user.
